(19) United States
(12) Patent Application Publication
(10) Pub. No.: US 2020/0009434 A1
(43) Pub. Date: Jan. 9, 2020

(54) Wheeled Golf Bag

(71) Applicant: Christopher Klein, Mt. Vernon, IL (US)

(72) Inventor: Christopher Klein, Mt. Vernon, IL (US)

(21) Appl. No.: 16/177,524

(22) Filed: Nov. 1, 2018

Related U.S. Application Data
(60) Provisional application No. 62/694,086, filed on Jul. 5, 2018.

(51) Int. Cl. A63B 55/60; B62B 5/00; A63B 55/30; B62B 5/06

(52) U.S. Cl. CPC A63B 55/60; B62B 5/0083; B62B 2202/406; B62B 5/067; A63B 55/30

(57) ABSTRACT

A wheeled golf bag. The wheeled golf bag includes a telescopic handle disposed on an upper portion thereof, and a pair of wheels disposed on a lower portion thereof. The telescopic handle is configured to be retracted into a handle sleeve so that the wheeled golf bag is more compact, and to be extended out of the handle sleeve to provide leverage to controllably roll the wheeled golf bag. A portion of each wheel of the pair of wheels is inset into the lower portion of the wheeled golf bag, such that the pair of wheels may not contact a ground when the wheeled golf bag is placed in an upright orientation. When the wheeled golf bag is placed in an angled orientation, the pair of wheels contact the ground to configure the wheeled golf bag to be rolled.

### CROSS REFERENCE TO RELATED APPLICATIONS

This application claims priority under 35 U.S.C. § 119(e) to U.S. Provisional Application No. 62/694,086 filed on Jul. 5, 2018. The above identified patent application is incorporated by reference herein in its entirety to provide continuity of disclosure.

### BACKGROUND OF THE INVENTION

The present invention relates to a wheeled golf bag for ergonomic transport of golf supplies.

Individuals who regularly transport golf supplies, including golfers, caddies, and the like, often sustain injury or fatigue as a result of their efforts. This occurs because existing golf bags are difficult to carry in an ergonomic manner due to the extended distribution of weight along the length of the golf bag. Design approaches to make golf bags more compact, and thus able to be carried closer to an individual's center of mass, may alleviate risk of injury or fatigue. However, this approach may be undesirable, because a compact golf bag would necessarily expose some number or portion of the golf supplies to the environment, and the ability of such a design to retain and protect the golf supplies would be diminished.

Therefore, there is a need in the art for a wheeled golf bag for ergonomic transport of golf supplies. The present invention addresses this unmet need.

Devices have been disclosed in the art that relate to transport of golf supplies. These include devices that have been patented and published in patent application publications. These devices are often overly complex, having too many moving parts and components, and are difficult to make or use. In view of the devices disclosed in the art, it is submitted that there is a need in the art for an improvement to existing devices for transport of golf supplies. In view of the present disclosure, it is submitted that the present invention substantially diverges in structural and functional elements from devices in the art, and the present invention substantially fulfills an unmet need in the art.

### SUMMARY OF THE INVENTION

In view of the disadvantages inherent in the known types of golf supply transport devices in the art, the present invention provides a new and improved wheeled golf bag, wherein the same can be utilized for ergonomic transport of golf supplies.

It is therefore an object of the present invention to provide a wheeled golf bag for ergonomic transport of golf supplies.

In one aspect, the invention provides a wheeled golf bag, comprising a telescopic handle disposed on an upper portion thereof, and a plurality of wheels fixedly disposed on a lower portion thereof. A wheel housing portion of the lower portion of the wheeled golf bag houses a portion of each wheel of the plurality of wheels. If the wheeled golf bag contacts (e.g., rests on) a surface in an upright orientation, the lower portion, or one or more pegs thereon, contacts the surface to configure the wheeled golf bag to be stationary. If the wheeled golf bag contacts (e.g., rests on) the surface in an angled orientation, the lower portion, or the one or more pegs thereon, does not contact the surface, and each wheel of the plurality of wheels contacts the surface to configure the wheeled golf bag to be rolled.

In various embodiments, the lower portion includes one or more pegs, such as rubber, metal, or alloy pegs, thereon, which contact the surface to protect the structural integrity of the wheeled golf bag. In some embodiments, the wheeled golf bag includes a battery disposed in an interior thereof, and a charging port disposed on an exterior thereof. In such embodiments, the charging port is operably connected to the battery to enable the battery to charge an electronic device via the charging port.

Another object of the present invention is to provide a wheeled golf bag that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a perspective view of an exemplary wheeled golf bag.

FIG. 2 depicts a close-up perspective view of a lower portion of the exemplary wheeled golf bag, which includes a plurality of wheels, and a plurality of pegs.

FIG. 3 depicts a close-up bottom perspective view of the lower portion of the exemplary wheeled golf bag, which includes the plurality of wheels, and the plurality of pegs.

FIG. 4 depicts a perspective view of a telescopic handle of the exemplary wheeled golf bag.

FIG. 5 depicts a perspective view of a charging port of the exemplary wheeled golf bag.

FIG. 6 depicts a perspective view of the exemplary wheeled golf bag, in an angled orientation and configured to be rolled, being rolled by an individual.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

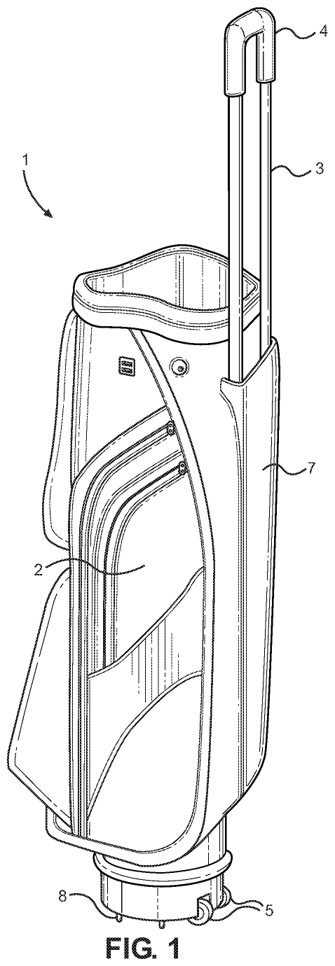

Referring now to FIG. 1, there is depicted a perspective view of an exemplary wheeled golf bag. A wheeled golf bag 1 includes a bag portion 2, having a plurality of pockets thereon and/or therein for removably storing or securing golf supplies and accessories. The wheeled golf bag 1 includes a telescopic handle 4 disposed on an upper portion thereof. A position of the telescopic handle 4 is vertically adjustable, for example, to configure the wheeled golf bag 1 for storage (e.g., a retracted configuration) or use (e.g., an extended configuration). The wheeled golf bag also includes a plurality of wheels 5, fixedly disposed on a lower portion thereof, such that a wheel housing portion of the lower portion houses a portion of each wheel of the plurality of wheels 5. In the shown embodiment, the wheel housing portion of the lower portion permanently houses the portion of each wheel of the plurality of wheels 5.

If the wheeled golf bag 1 rests on a surface in an upright orientation (e.g., as depicted in FIG. 1), the lower portion, or one or more pegs 8 positioned thereon, contacts the surface to configure the wheeled golf bag 1 to be stationary. Similarly, if the wheeled golf bag 1 rests on the surface in an angled orientation, the lower portion, or the one or more pegs 8 positioned thereon, does not contact the surface, and one or more wheels of the plurality of wheels 5 contacts the surface to configure the wheeled golf bag to be rolled.

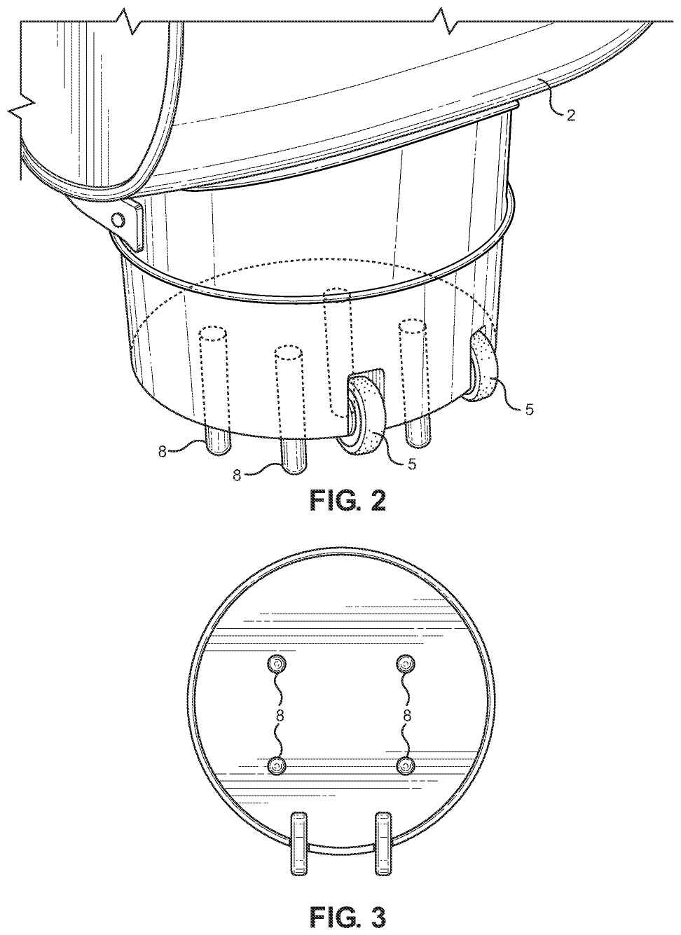

Referring now to FIGS. 2 and 3, there are depicted a close-up perspective view (FIG. 2), and a close-up bottom perspective view (FIG. 3), of a lower portion of the exemplary wheeled golf bag. In the shown embodiment, the lower portion 2 of the wheeled golf bag includes the plurality of wheels 5, and the one or more pegs 8. The plurality of wheels 5 is configured, by way of a size, a material, and a placement of wheels of the plurality of wheels 5 on a bottom surface of the wheeled golf bag, to support all or a portion of a weight of the wheeled golf bag, and to enable an individual to roll the wheeled golf bag on a surface thereunder. The one or more pegs 8 are configured, by way of their width, length, material, and attachment to the bottom surface of the wheeled golf bag, to support all or a portion of the weight of the wheeled golf bag, and to protect the lower portion 2 of the wheeled golf bag from contact with the surface thereunder, which may damage the structure of the lower portion 2.

Generally, the one or more pegs 8, and the plurality of wheels 5, each may be comprised of any material suited to support the wheeled golf bag and minimize undesired slippage on the surface thereunder. Exemplary materials for these components includes a rubber, a plastic or another polymer, a metal or an alloy, and the like. In some embodiments, a bottom surface of the one or more pegs 8, and/or a surface-contacting portion of the plurality of wheels 5, includes a high-friction pattern or design of indentations or extensions (e.g., a tread pattern) thereon, so as to further minimize slippage by increasing or maximizing frictional engagement with the surface thereunder.

In the shown embodiment, the one or more pegs 8 are fixed to the lower portion 2, but in alternate embodiments, the one or more pegs 8 are removably attached to the lower portion 2, and/or may be adjustable. In this manner, to configure the wheeled golf bag to be placed upright (e.g., in a standing position), on a smooth or regular surface, the one or more pegs 8 may be removed, or retracted such that they are relatively shorter. Similarly, to configure the wheeled golf bag to be placed upright on a coarse or irregular surface (e.g., a rough of a golf course), the one or more pegs 8 may be attached, or extended such that they are relatively longer. Further, all or a portion of the one or more pegs 8 may be wider to configure the wheeled golf bag to be stable or sturdy when in the standing position in a soft portion of the surface or a ground, including but not limited to a muddy or saturated area of earth, or a sand bank of the golf course. In like manner, the bottom surface of the one or more pegs 8, and/or the plurality of wheels 5, may be wider than shown, so as to increase a stability of the wheeled golf bag when navigating irregular terrain.

In the shown embodiment, the one or more pegs 8 includes four pegs 8, and the plurality of wheels 5 includes two wheels 5. Generally, the wheeled golf bag may need at least two wheels 5 thereon, but in certain embodiments, the one or more pegs 8 are an optional feature of the invention. In such embodiments, at least the lower portion 2 of the wheeled golf bag may be firmer, tougher, harder, or more durable, so as to enable the lower portion 2 to interact directly with the surface or ground thereunder during use.

In embodiments having the pegs 8 on the lower portion 2, alternate numbers and arrangements are also envisioned as part of the present invention. For example, a single peg 8 may be utilized to support the wheeled golf bag, and positioned so as to form a single peg-mediated contact with the surface thereunder to stabilize the wheeled golf bag in the upright position. In such embodiments, in the upright position, it may be desired that two or more of the plurality of wheels 5 also contact the surface thereunder, so as to stabilize the wheeled golf bag on the surface by having a necessary number of points of contact with the surface to achieve stability. In some embodiments, there may be one, two, three, five, or more pegs 8 on the lower portion 2. Generally, an appropriate number of pegs 8 would optimize the stability of the wheeled golf bag in the upright position, and also optimize a degree of pressure applied to the one or more pegs 8 in the upright position (e.g., a weight resting on each peg 8).

To facilitate controlled rolling of the wheeled golf bag, it may be desired that at least two wheels 5 be included on the wheeled golf bag. However, alternate numbers of wheels 5 are also envisioned as part of the present invention. For example, three, four, or more wheels 5 may be included so as to increase contact between the wheels 5 and the surface thereunder, thereby increasing stability or durability of the wheeled golf bag.

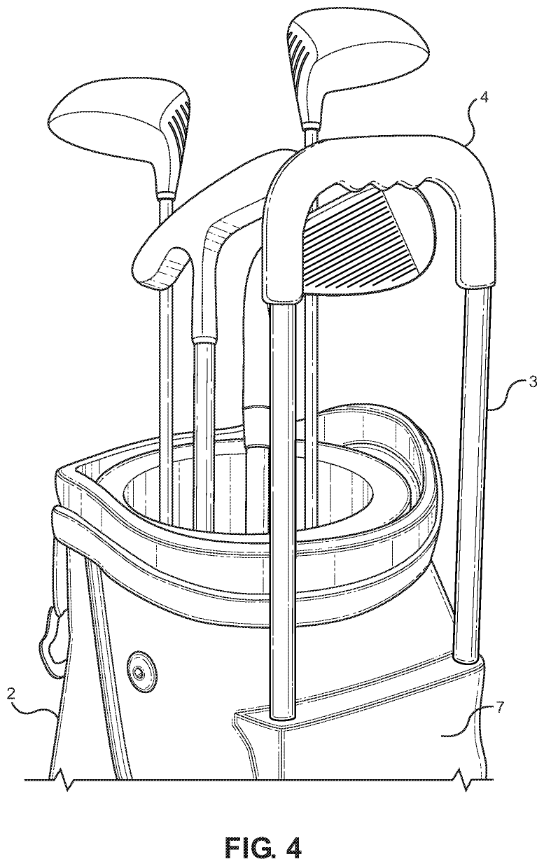

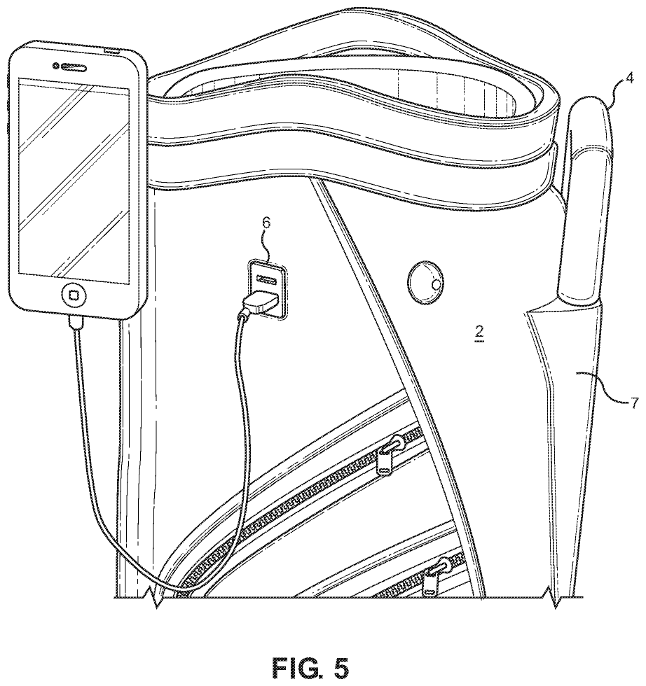

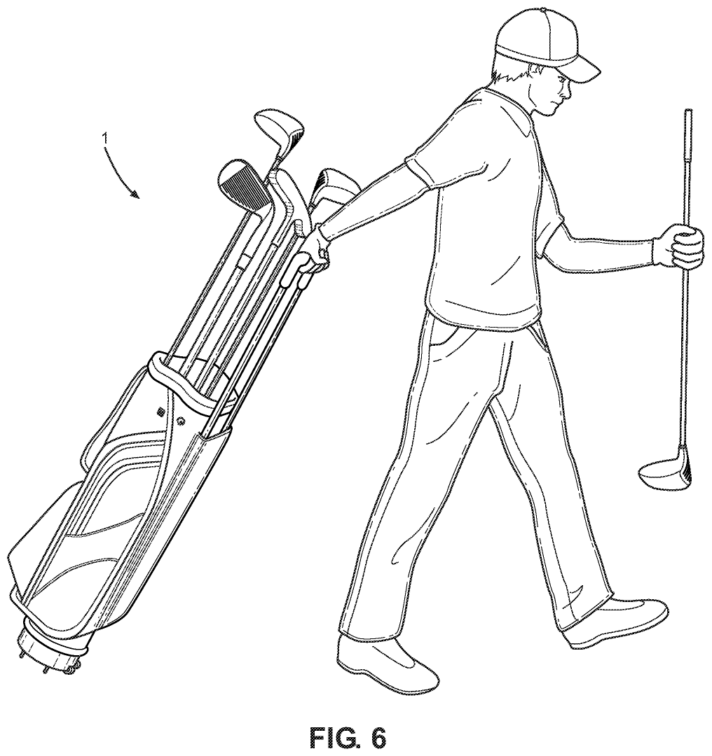

Referring now to FIGS. 1, 4, 5, and 6, there are depicted a perspective view of the exemplary wheeled golf bag (FIG. 1), as well as a telescopic handle (FIG. 4), and a charging port (FIG. 5) thereof, and an example of an individual rolling the wheeled golf bag (FIG. 6). In the shown embodiment, the wheeled golf bag 1 includes a handle sleeve 7 disposed on the wheeled golf bag 1, such that if the telescopic handle 4 is in a retracted configuration, the telescopic handle 4 is mostly inside of the handle sleeve 7 (see FIG. 5), and if the telescopic handle 4 is in an extended configuration, the telescopic handle 4 is mostly outside of the handle sleeve 7 (see FIG. 1). In this manner, the telescopic handle 4 can be retracted to configure the wheeled golf bag 1 for storage, such as in an interior of a vehicle, and can be extended to configure the wheeled golf bag 1 for transport by an individual (see FIG. 5).

In the shown embodiment, the telescopic handle 4 includes a hand grip thereon. Generally, the hand grip is sized and configured to be easily held by a hand of the individual, to facilitate rolling or maneuvering the wheeled golf bag 1 during transport. The hand grip may be composed of any relatively high-friction material suitable for its purpose, such as rubber, plastic, and the like.

In the shown embodiment, the telescopic handle 4 is comprised of a plurality of vertical handle members 3. In the shown embodiment, the plurality of vertical handle members includes two vertical handle member 3 which are joined together by a horizontal handle member disposed on an upper portion of each vertical handle member of the plurality of vertical handle members 3. In this manner, a movement of the hand of the individual rolling or transporting the wheeled golf bag 1 can steer or direct the wheeled golf bag 1 around corners or obstacles during transport or use.

In some embodiments, the telescopic handle 4 includes a locking mechanism configured to enable the individual to selectively lock the telescopic handle 4 in a fully extended configuration, a partially extended configuration, or a retracted configuration. In this manner, the wheeled golf bag 1 can be custom fit to be easily used by individuals of a range of different heights and statures. In alternate embodiments, the upper portion of the wheeled golf bag 1 includes a flange thereon, such that the flange is sized and configured to enable the individual to grab the wheeled golf bag 1 using the flange thereon. In this manner, the individual can easily reorient or reposition the wheeled golf bag 1 without accidentally extending the telescopic handle 4 or rolling the wheeled bag 1 on the surface.

In the shown embodiment, the bag portion 2 includes a charging port 6 disposed on a surface of the bag portion 2 opposite or adjacent to the telescopic handle 4. The charging port 6 may be desirable so as to enable the individual using the wheeled golf bag 1 the option to charge an electronic device (e.g., a mobile phone) using the charging port 6 of the wheeled golf bag 1. In this manner, the individual will be able to use their electronic device during a golf outing, even if the electronic device has a reduced or depleted battery charge.

In such embodiments, the charging port 6 is operably connected to a charging mechanism, disposed in an interior of the wheeled golf bag, such as the bag portion 2. The charging mechanism includes a battery, such as a rechargeable battery. In some embodiments, the battery may be recharged by rotational energy generated by the plurality of wheels during rolling of the wheeled golf bag. In some embodiments, the battery may be recharged by a solar panel, which may optionally be disposed on the wheeled golf bag 1. In other embodiments, the battery may be recharged by connecting the battery to a supply of alternating current, as may be obtained from a standard wall outlet or other source of electrical energy, as would be understood by the individual. In some embodiments, an exterior of the bag portion 2 includes means to hold or secure the electronic device (e.g., the mobile phone) to the bag portion 2, as may be desired when charging the electronic device with the charging mechanism. Exemplary means to hold or secure the electronic device include, but is not limited to: a pocket or an elastic pocket, a strap or an elastic strap, and a netting or an elastic netting.

As depicted in FIG. 1, the wheeled golf bag 1 is oriented such that it rests on the surface in the upright orientation, and as depicted in FIG. 6, the wheeled golf bag 1 is oriented such that it rests on the surface in the angled orientation (i.e., such that the lower portion, or one or more pegs thereon, does not contact the surface, and such that each wheel of the plurality of wheels contacts the surface). In this manner, in the angled orientation, the wheeled golf bag 1 is configured to be rolled. After being configured as such, the wheeled golf bag 1 can be rolled on the surface to transport golf supplies in an ergonomic and safe manner.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A wheeled golf bag, comprising:
a telescopic handle disposed on an upper portion thereof;
a plurality of wheels fixedly disposed on a lower portion thereof, wherein a wheel housing portion of the lower portion houses a portion of each wheel of the plurality of wheels;
wherein if the wheeled golf bag contacts a surface in an upright orientation, the lower portion, or one or more pegs thereon, contacts the surface to configure the wheeled golf bag to be stationary;
wherein if the wheeled golf bag contacts the surface in an angled orientation, the lower portion, or the one or more pegs thereon, does not contact the surface, and each wheel of the plurality of wheels contacts the surface to configure the wheeled golf bag to be rolled.

2) The wheeled golf bag of claim 1, further comprising a handle sleeve disposed on the wheeled golf bag,
wherein if the telescopic handle is in a retracted configuration, the telescopic handle is mostly inside of the handle sleeve;
wherein if the telescopic handle is in an extended configuration, the telescopic handle is mostly outside of the handle sleeve.

3) The wheeled golf bag of claim 1, further comprising a hand grip disposed on an upper portion of the telescopic handle.

4) The wheeled golf bag of claim 1, wherein the telescopic handle is comprised of a pair of vertical handle members, wherein the pair of vertical handle members are joined together by a horizontal handle member disposed on an upper portion of each vertical handle member of the pair of vertical handle members.

5) The wheeled golf bag of claim 2, further comprising a hand grip disposed on an upper portion of the telescopic handle.

6) The wheeled golf bag of claim 2, wherein the telescopic handle is comprised of a pair of vertical handle members, wherein the pair of vertical handle members are joined together by a horizontal handle member disposed on an upper portion of each vertical handle member of the pair of vertical handle members.

7) The wheeled golf bag of claim 3, further comprising a handle sleeve disposed on the wheeled golf bag,
wherein if the telescopic handle is in a retracted configuration, the telescopic handle is mostly inside of the handle sleeve;
wherein if the telescopic handle is in an extended configuration, the telescopic handle is mostly outside of the handle sleeve.

8) The wheeled golf bag of claim 3, wherein the telescopic handle is comprised of a pair of vertical handle members, wherein the pair of vertical handle members are joined together by a horizontal handle member disposed on an upper portion of each vertical handle member of the pair of vertical handle members.

9) The wheeled golf bag of claim 4, further comprising a handle sleeve disposed on the wheeled golf bag,
wherein if the telescopic handle is in a retracted configuration, the telescopic handle is mostly inside of the handle sleeve;
wherein if the telescopic handle is in an extended configuration, the telescopic handle is mostly outside of the handle sleeve.

10) The wheeled golf bag of claim 4, further comprising a hand grip disposed on an upper portion of the telescopic handle.

11) The wheeled golf bag of claim 5, wherein the telescopic handle is comprised of a pair of vertical handle members, wherein the pair of vertical handle members are joined together by a horizontal handle member disposed on an upper portion of each vertical handle member of the pair of vertical handle members.

12) The wheeled golf bag of claim 6, further comprising a hand grip disposed on an upper portion of the telescopic handle.

13) The wheeled golf bag of claim 7, wherein the telescopic handle is comprised of a pair of vertical handle members, wherein the pair of vertical handle members are joined together by a horizontal handle member disposed on an upper portion of each vertical handle member of the pair of vertical handle members.

14) The wheeled golf bag of claim 8, further comprising a handle sleeve disposed on the wheeled golf bag,
wherein if the telescopic handle is in a retracted configuration, the telescopic handle is mostly inside of the handle sleeve;
wherein if the telescopic handle is in an extended configuration, the telescopic handle is mostly outside of the handle sleeve.

15) The wheeled golf bag of claim 9, further comprising a hand grip disposed on an upper portion of the telescopic handle.

16) The wheeled golf bag of claim 10, further comprising a handle sleeve disposed on the wheeled golf bag,
wherein if the telescopic handle is in a retracted configuration, the telescopic handle is mostly inside of the handle sleeve;
wherein if the telescopic handle is in an extended configuration, the telescopic handle is mostly outside of the handle sleeve.

17) A wheeled golf bag, comprising:
a telescopic handle disposed on an upper portion thereof;
a plurality of wheels fixedly disposed on a lower portion thereof, wherein a wheel housing portion of the lower portion houses a portion of each wheel of the plurality of wheels;
a battery disposed in an interior thereof;
a charging port disposed on an exterior thereof, wherein the charging port is operably connected to the battery to enable the battery to charge an electronic device via the charging port;
wherein if the wheeled golf bag contacts a surface in an upright orientation, the lower portion, or one or more pegs thereon, contacts the surface to configure the wheeled golf bag to be stationary;
wherein if the wheeled golf bag contacts the surface in an angled orientation, the lower portion, or the one or more pegs thereon, does not contact the surface, and each wheel of the plurality of wheels contacts the surface to configure the wheeled golf bag to be rolled.

18) The wheeled golf bag of claim 17, further comprising a handle sleeve disposed on the wheeled golf bag,
wherein if the telescopic handle is in a retracted configuration, the telescopic handle is mostly inside of the handle sleeve;
wherein if the telescopic handle is in an extended configuration, the telescopic handle is mostly outside of the handle sleeve.

19) The wheeled golf bag of claim 17, further comprising a hand grip disposed on an upper portion of the telescopic handle.

20) The wheeled golf bag of claim 17, wherein the telescopic handle is comprised of a pair of vertical handle members, wherein the pair of vertical handle members are joined together by a horizontal handle member disposed on an upper portion of each vertical handle member of the pair of vertical handle members.
